(19) United States
(12) Patent Application Publication
(10) Pub. No.: US 2022/0308367 A1
(43) Pub. Date: Sep. 29, 2022

(54) EYEWEAR HAVING AN ANTI REFLECTIVE PORTION

(71) Applicant: Brent Sheldon, Miami Beach, FL (US)

(72) Inventor: BRENT SHELDON, Miami Beach, FL (US)

(21) Appl. No.: 17/840,282

(22) Filed: Jun. 14, 2022

Related U.S. Application Data
(63) Continuation of application No. PCT/CA2020/051794, filed on Dec. 23, 2020.
(60) Provisional application No. 62/952,739, filed on Dec. 23, 2019.

(51) Int. Cl. G02C 11/00; G02B 1/11

(52) U.S. Cl. CPC G02C 11/12; G02B 1/11

(57) ABSTRACT

A common problem with eyewear is the lack of protection from external elements as chemicals, foreign objects or sunlight. Another common problem with eyewear is known as back-glare. There is provided an eyewear frame comprising lens retainers, a pair of arms, a nose bridge portion and side shields attached to the pair of arms. The side shields consist of attachment members which can be inserted into to recesses formed in the arms. The side shields can be made from an anti-reflective material which provides protection against external elements as chemicals, foreign objects or sunlight. The side shields made from anti-reflective materials also reduce the amount of back-glare.

### CROSS-REFERENCE TO RELATED APPLICATIONS

The present application is a continuation of PCT Application No. PCT/CA2020/051794 filed Dec. 23, 2020, which claims priority from U.S. Provisional Application No. 62/952,739 filed Dec. 23, 2019, the contents of both incorporated herein by reference in their entireties.

### TECHNICAL FIELD

The following relates generally to eyewear, and more specifically to such eyewear having anti-reflective properties.

### BACKGROUND

Eyewear such as eyeglasses generally include a frame that supports one or more lenses. The frame typically includes a nose bridge or nose pieces that engage the user's nose to support the eyewear on the user's head. Eyeglasses also typically include a pair of arms attached to (or integral with) the frame, to further support the eyeglasses, e.g. by resting the arms on the user's ears or engaging their head in the temple region.

However, a common problem with eyewear is the lack of protection from external elements as dust, debris, vapors, chemicals, foreign objects or sunlight. To solve this problem, eyewear may include shields to protect the wearer's eyes and face the from external elements. For example, sunglasses use dark lenses to protects the wearer's eyes from sunlight. Safety goggles may contain side-shields to block foreign objects or chemicals from passing through to the user. Side shields alone may not prevent external elements from entering the wearer's eye area. For example, safety goggles having side shields may not always prevent chemicals or liquids from entering the eye area.

Another common problem with eyewear is known as back-glare. This is light that hits the back of the lenses and bounces into the eyes. If the eyewear includes side shields, then there can be an increased amount of back-glare incoming from the peripherals of the wearer's sight. Back-glare may cause a constant reflection, or glare seen by the wearer on the lens of the eyewear. This can have many disadvantages; for example: back-glare can be dangerous when the wearer is driving or operating machinery.

It is an object of the following to address at least one of the above-noted disadvantages.

### SUMMARY

In one aspect, eyewear is taught which may comprise: a frame portion having a first and a second lens retainer, a pair of arms having at least one recess, at least one lateral protective member, and a nose bridge connecting the first and the second lens retainers thereto. The eyewear can further comprise first and second lens for inserting into the first and the second lens retainers. The at least one lateral protective member can be removably attached to the frame portion. The at least one lateral protective member may be coated with an anti-reflective material. It should be visibly apparent to a user that the anti-reflective material has been applied to the lateral protective member.

The lateral protective member may be attached to and extend from at least one recesses of the pair of arms. The lateral protective member can be inserted into the at least one recesses of the arm by a snap-in mechanism and/or magnetic mechanism. The anti-reflective material may be applied to the lateral protective member or lens carrier using at least one of: dip coating, spray coating, explosion coating, and electroplating. A marking can be applied to the lateral protective member once the anti-reflective material is applied to the lateral protective member to make it visibly apparent to a user that the coating has been applied.

In another aspect, a method of manufacturing eyewear is taught. The method can comprise: forming a frame portion having a first and a second lens retainer, a pair of arms having at least one recess, and a nose bridge connecting the first and the second lens retainers thereto; inserting a first and second lens into the first and the second lens retainers; forming at least one lateral protective member having at least one attachment member; coating the at least one lateral protective member with an anti-reflective material; applying a marking to the at least one lateral protective member once the anti-reflective material coating has been applied to make it visibly apparent that a coating has been applied; and attaching the at least one lateral protective member to the recesses of the at least one pair of arms.

In yet another aspect, eyewear comprising an antireflective lens carrier is taught herein. The eyewear can comprise: a frame portion having a pair of arms and a brow bar having at least one recess. The lens carrier can comprise: a first and a second lens retainers attached together by a nose bridge portion; and a first and second lens for inserting into the first and second lens retainers. The lens carrier can be coated with an anti-reflective material; and it should be visibly apparent to a user that the anti-reflective material has been applied to the lens carrier.

There is also provided an eyewear frame comprising lens retainers, a pair of arms, a nose bridge portion and side shields attached to the pair of arms. The side shield can be made from an anti-reflective material and preferably removably attached to the eyewear frame. The side shields consist of attachment members which can be inserted into to recesses formed in the arms.

There is further provided an eyewear frame comprising a frame portion having a nose bridge portion, a brow bar, and a pair of arms. A lens carrier having an empty space for receiving lens can be attached to recesses formed in the brow bar and the arms of the frame portion. The lens carrier additionally consists of a side shield and attachment members which can be inserted into to recesses formed in the arms. The lens carrier can be made from an anti-reflective material and preferably removably attached to the eyewear frame.

### BRIEF DESCRIPTION OF THE DRAWINGS

Embodiments will now be described with reference to the appended drawings wherein:

FIG. 1 is a perspective view of a pair of eyeglasses having anti-reflective side shields;

FIG. 2 is an exploded perspective view of the eyeglasses shown in FIG. 1;

FIG. 3 is a perspective view of the anti-reflective side shield shown in FIG. 2;

FIG. 4 is a front perspective view of a pair of eyeglasses having an anti-reflective lens carrier;

FIG. 5 is an exploded perspective view of the eyeglasses shown in FIG. 4;

FIG. 6 is a perspective view of the anti-reflective lens carrier shown in FIG. 5;

FIG. 7 is a photograph of perspective view of the anti-reflective side shield showing a marking; and

FIG. 8 is a photograph of perspective view of the anti-reflective lens carrier showing a marking.

### DETAILED DESCRIPTION

It should also be noted that throughout the following description and claims, the terms “front”/“forward” and “back”/“rearward” (“rear”) refer to directions from the perspective of the user—i.e. further away from the user's face is referred to as “front” or “forward” and closer to the user's face is referred to as “back” or “rear”.

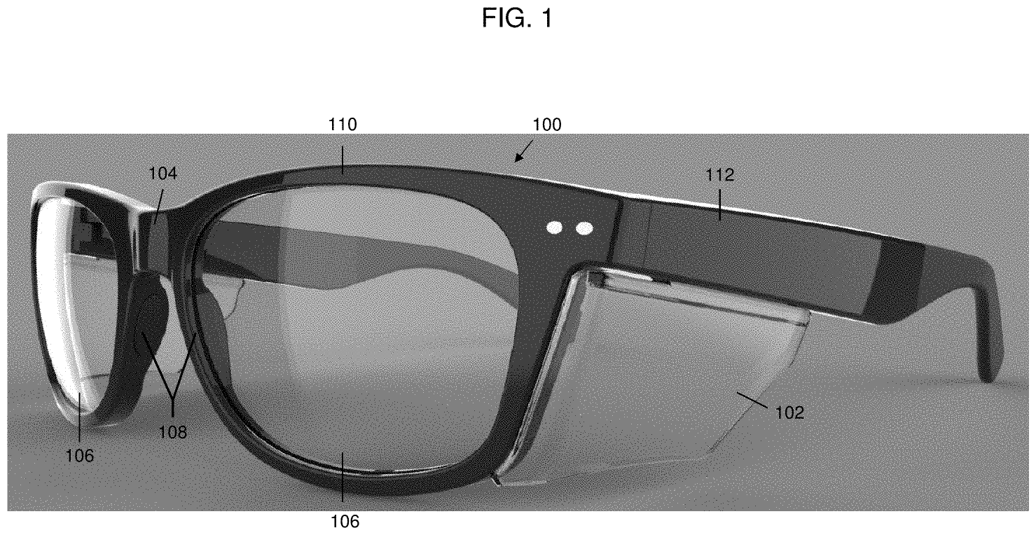

Turning now to the figures, FIG. 1 provides a perspective view of eyewear 100 having side shields 102. Side shields 102 may also be referred to as lateral protective members 102. The frame of the eyewear 100 typically includes a pair of arms 112, a first and second lens retainer 110a 110b, and a nose bridge portion 104 connecting the first lens retainer 110a to the second lens retainer 110b. Lens 106 can be placed within the lens retainers 110 and can provide a variety of functions such as vision correction or can act as a shield from sunlight or external objects. To enhance the shielding capabilities of the eyewear, a side shield 102 can be attached to one or both the arms 112. The side shield provides further protection from external objects and protects the sides of the user's face. This can be particularly useful in situations such as a chemical lab environment where the wearer may be exposed to harmful or corrosive chemicals. The side shields may help to protect the chemicals from splashing on the side of a wearer's face. Furthermore, the side shields may also be coated with, or constructed from, an anti-reflective material or a combination of anti-reflective materials. The anti-reflective (AR) material can be applied to the side shields to reduce back glare and additionally allow external liquids such as chemicals or water to roll off easily.

An AR material or coating is a type of optical coating typically applied to the surface of lenses to reduce reflection. Applying this coating to the surface of the lenses may improve the efficiency of the lenses since less light is lost due to reflection. In other applications, the primary benefit is the elimination of the reflection itself, such as a coating on eyeglass lenses that makes the eyes of the wearer more visible to others. The side shields 102 can be constructed from a material which is intrinsically anti-reflective or a material which has been coated with an anti-reflective coating.

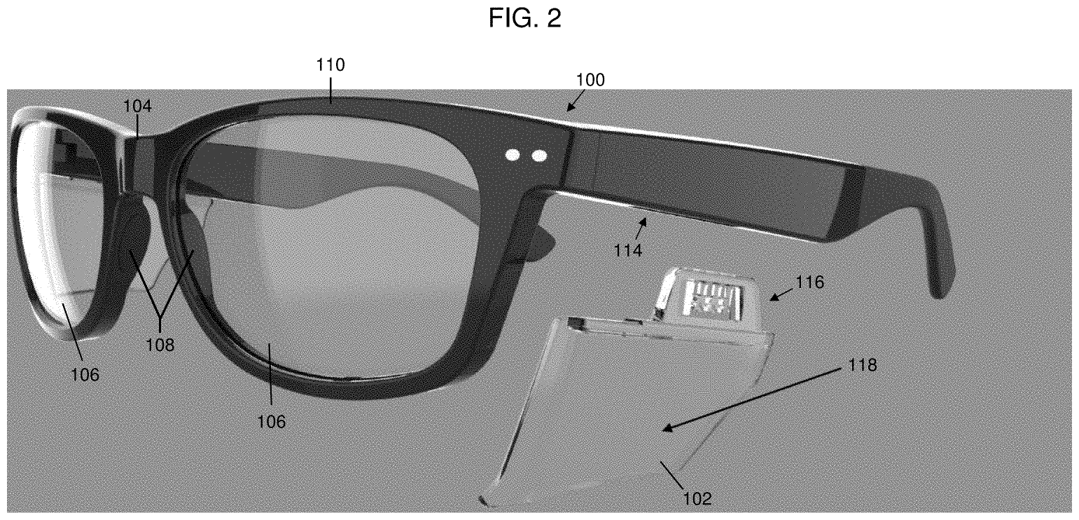

FIG. 2 provides an exploded perspective view of the eyeglasses. The side shields 102 are connected to the eyewear frame 100 by attachment members 116. In this embodiment, the arms 112 are provided with slots or recesses 114 which are sized to fit the attachment members 116. The side shields 102 can be inserted into the recesses of the frame via the attachment members 116. The side shields 102 can be inserted by a snap-in mechanism. Optionally, the side shields 102 can also be magnetically inserted. Fasteners such as screws may also be used to join the side shields 102 to the frame 100 or arms 112.

The attachment members may include notches for securing the side shields 102 to the frame 100. The eyewear 100 may be assembled by inserting or snapping the attachment member 116 of the side shield 102 into the recesses 114 of the frame arms 112. Snapping the attachment members 116 into the recesses 114 can cause the attachment member 116 to deform slightly before it is seated within the recesses 114. The side shields can be snapped into the arms 112 or the frame permanently or detachably. The recess 114 can optionally be located along the edge of the lens retainer 110. The attachment member 116 may contain notches 122 to aide in insertion into the recesses 114 of the arms 112.

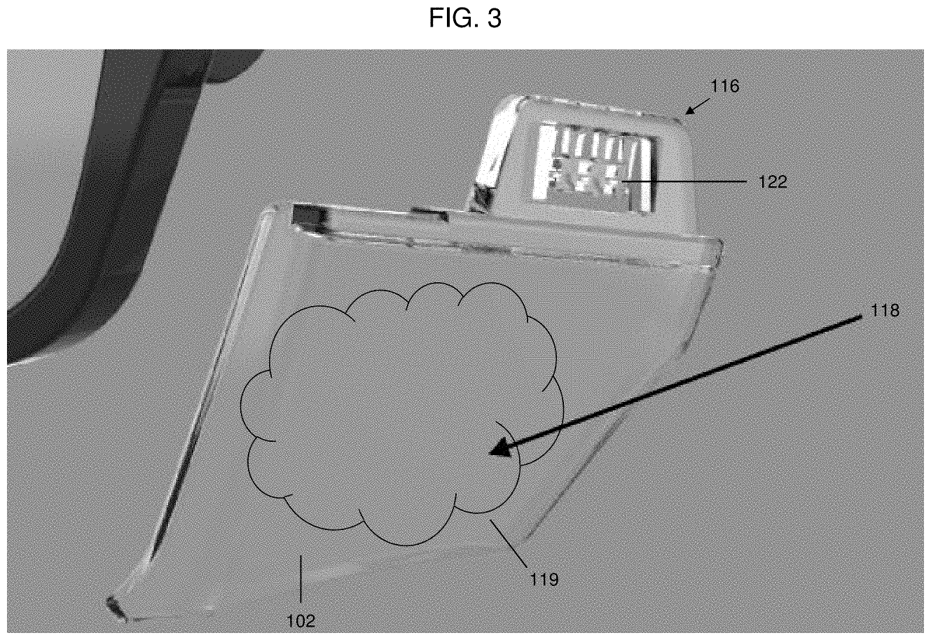

FIG. 3 provides a perspective view of the anti-reflective side shield shown in FIG. 2. The side shields 102 may be constructed from a material which is intrinsically anti-reflective or a material which has been coated with an anti-reflective coating 118.

A method of producing eyewear having AR side shields 102 is also provided. A side shield 102 having attachment members 116 is formed using a suitable method such as co-injecting or injection molding. The side shields 102 may be constructed from a material which is intrinsically anti-reflective such as glass or crystal. Optionally, certain plastics may be used. It can be appreciated that the side shields need not be transparent. To enhance the optical properties and the anti-reflective properties of the glass or crystal material, a material which has been coated with an anti-reflective coating 118 may also be used to form the side shields 102. A frame 100 having a pair of arms 112, a first and second lens retainer 110a 110b, and a nose bridge portion 104 connecting the first lens retainer 110a to the second lens retainer 110b is formed. Recesses 114 are formed on the arms 112 of the frame 100. Lens 106 can be placed within the lens retainers 110. The side shields 102 having the attachment members 116 are then inserted into the recesses 114.

Multiple lens grooves 201 can be formed on the lens portion 202. The lens grooves 201 can be formed using a CNC machining method or by injection molding the lens portion 202 having grooves 201, or a similar method known in the art. The nose bridge portion 203 can be formed separately from the pair of lens portions 202a and 202b. Multiple frame grooves 301 can be formed on the frame portion 302. The frame grooves 301 can also be formed using a CNC machining method or by injection molding the frame portion having grooves 301. The frame portion can be joined to the lens portion, aligning the lens grooves 201 to the frame grooves 301, and forming vents 310. The forming lens grooves 201 step involves cutting the lens grooves such that the lens grooves are angled in a plurality of directions. The forming frame grooves 301 step involves cutting the frame grooves 301 such that the frame grooves 301 are angled in a plurality of directions.

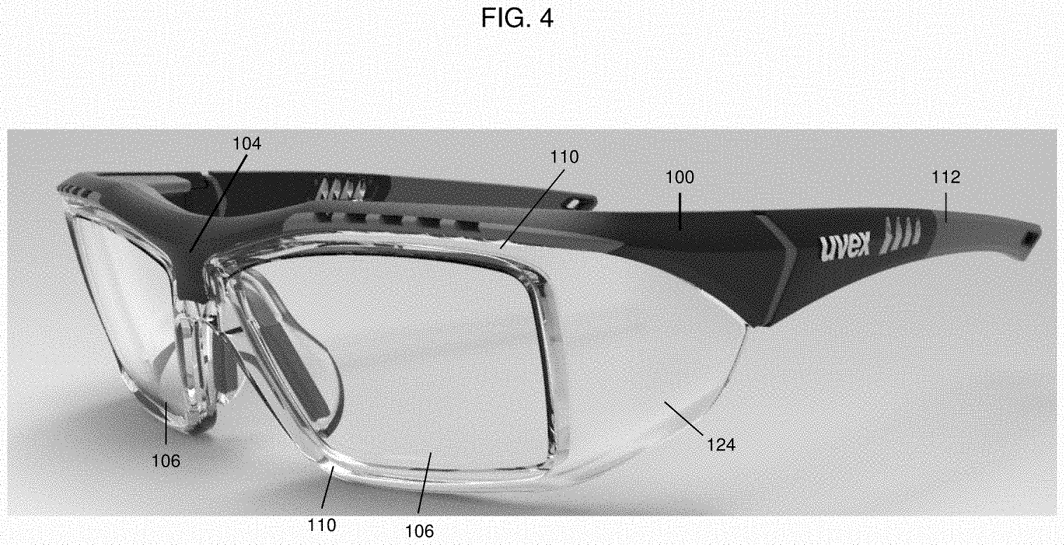

FIG. 4 shows an alternative embodiment of the eyewear having an anti-reflective lens carrier. In this instance, a front perspective view of a pair of eyeglasses having an anti-reflective lens carrier is shown. In this embodiment, a lens carrier 124 comprises the lens retainers 110 as well as the side shields 102 in a singular piece. The lens carrier 124 can be coated entirely with the AR material. The lens retainers 110 can extend beyond the lenses 106 and form the side shields 102.

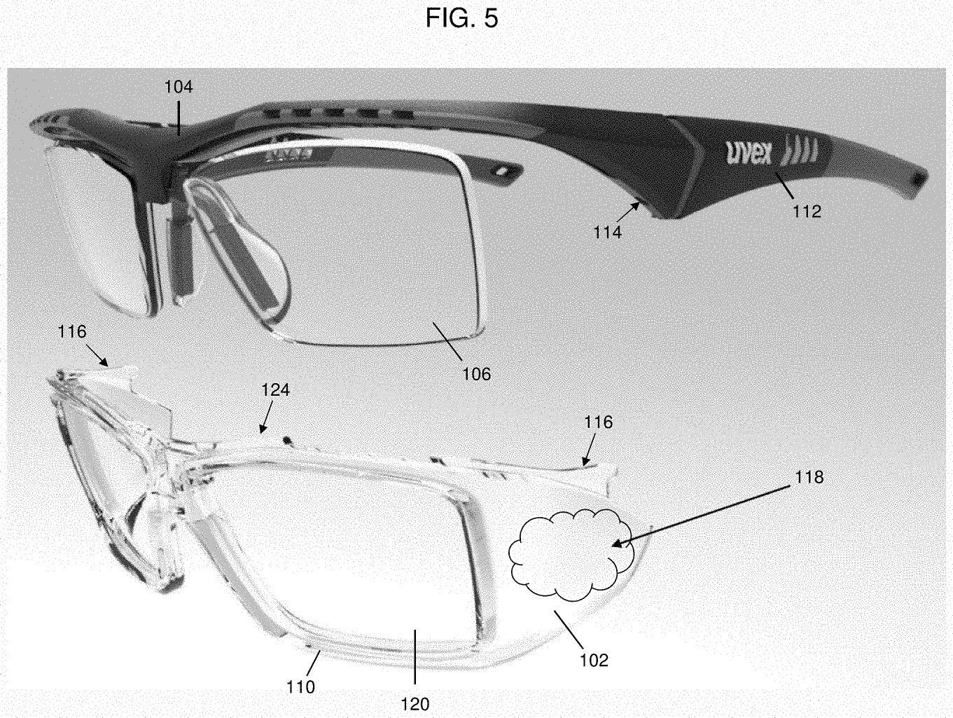

FIG. 5 is an exploded perspective view of the eyeglasses shown in FIG. 4. The lens carrier 124 is connected to the eyewear frame 100 by attachment members 116. In this embodiment, the arms 112 and the brow bar 104 are provided with slots or recesses 114 which are sized to fit the attachment members 116. The attachment members can be inserted into the recesses of the frame. The lens carrier 124 can be inserted by a snap-in mechanism or optionally, the lens carrier 124 can also be magnetically inserted. Fasteners such as screws may also be used to join the lens carrier 124 to the frame 100 or arms 112. The lens carrier 124 comprises lens retainers 110 characterized by the empty space 120 for receiving the lenses 106. The lens carrier 124 also comprises the side shields 102 having prongs 116. The prongs may have any suitable shape for inserting into the recesses of the arms 112 or brow bar 104. The prongs can be snapped into the arms 112 or the frame permanently or detachably. The attachment member 116 may contain notches 122 to aide in insertion into the recesses 114 of the arms 112.

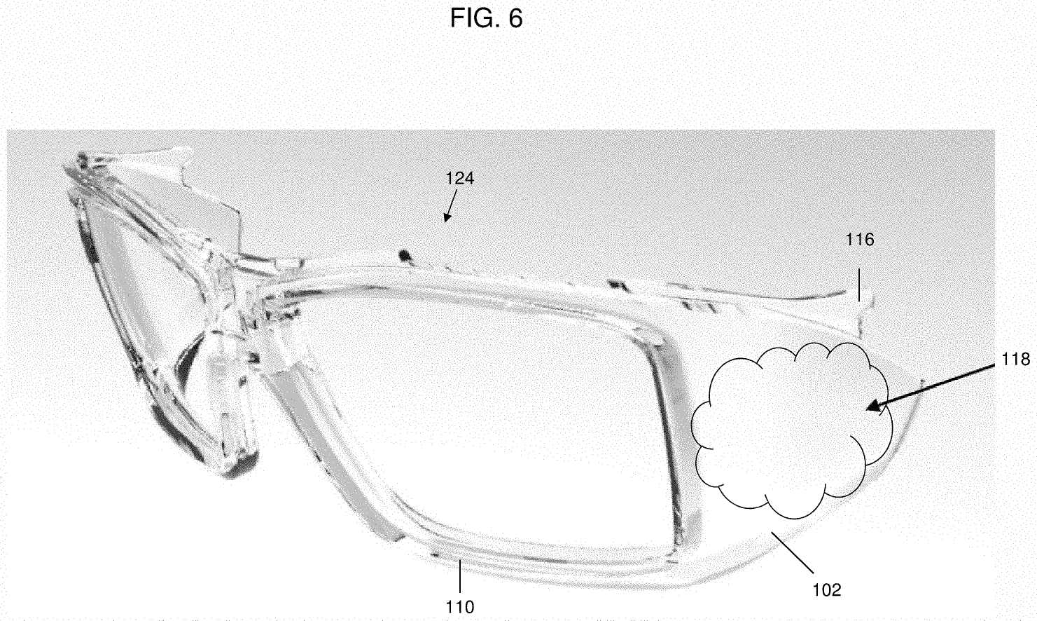

FIG. 6 is a perspective view of the anti-reflective lens carrier shown in FIG. 5. The lens carrier 124 may be constructed from a material which is intrinsically anti-reflective or a material which has been coated with an anti-reflective coating 118. The lens carrier 124 may be coated partially or coated entirely with the AR material.

The construction of the brow bar can be done using any suitable overmolding process. Overmolding, sometimes referred to as two times injection molding, is a process where a single part is created using two or more different materials in combination. Typically, the first material (or substrate) is partially or fully covered by overmolded material during the manufacturing process. In this case, the nose bridge 104 would act as the substrate that is overmolded with the material used to create the brow bar thereon, which is generally a softer plastic, rubber, or elastomer (e.g., PTE), or other suitable material. It can be appreciated that the flexible material would typically be overmolded to the frame 100, prior to attaching the lens carrier 124 to the frame 100. The lens 106 can be inserted into the empty space 120 either before or after attaching the lens carrier 124 to the frame 100.

A method of producing eyewear having an AR lens carrier 124 is also provided. A lens carrier 124 having attachment members 116 is formed using a suitable method such as co-injecting or injection molding. The lens carrier 124 may be constructed from a material which is intrinsically anti-reflective such as glass or crystal. Optionally, certain plastics may be used. It can be appreciated that the lens carrier 124 need not be transparent. To enhance the optical properties and the anti-reflective properties of the glass or crystal material, a material which has been coated with an anti-reflective coating 118 may also be used to form the lens carrier 124. A frame 100 having a pair of arms 112, a first and second lens retainer 110a 110b, and a nose bridge portion 104 connecting the first lens retainer 110a to the second lens retainer 110b is formed. Recesses 114 are formed on the arms 112 and the brow bar of the frame 100. Lens 106 can be placed within the lens retainers 110. The lens carrier 124 having the attachment members 116 is then inserted into the recesses 114.

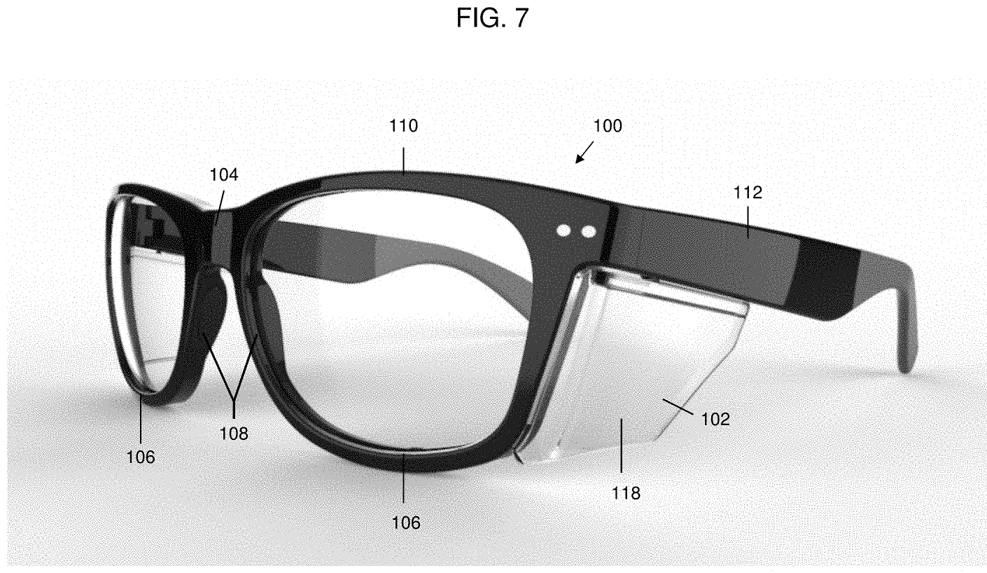

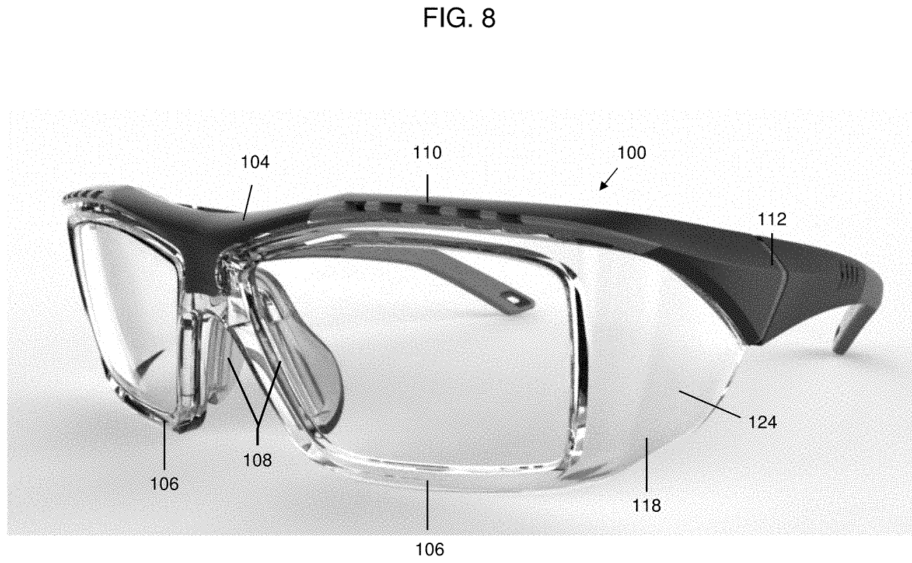

FIG. 7 is a photograph of perspective view of the anti-reflective side shield showing a marking. FIG. 8 is a photograph of perspective view of the anti-reflective lens carrier showing a marking. The marking can include the optical birefringence shown in FIGS. 7 and 8. In another embodiment, the eyewear can be marked with a special symbol or character to identify that an anti-reflective coating has been applied. This is so that a user is able to easily identify which eyewear has side shields or lens carriers that are coated with an anti-reflective coating.

After applying the anti-reflective coating, the light transmission value can increase. An increase in the light transmission value from 80% to 100% can be possible. An increase between 89-91% to 99% can be expected. The most probable increase is around 92-93%. Coating An increase in the light transmission value can result in more light that can pass through the eyewear parts after the coating, therefore it can result in a clearer, or better vision.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. Eyewear comprising:
a frame portion having a first and a second lens retainer, a pair of arms having at least one recess, at least one lateral protective member, and a nose bridge connecting the first and the second lens retainers thereto;
a first and second lens for inserting into the first and the second lens retainers; and
wherein the at least one lateral protective member is removably attached to the frame portion;
wherein the at least one lateral protective member is coated with an anti-reflective material; and
wherein it is visibly apparent to a user that the anti-reflective material has been applied to the lateral protective member.

2. The eyewear according to claim 1, wherein the lateral protective member is attached to and extends from at least one recesses of the pair of arms.

3. The eyewear according to claim 2, wherein the anti-reflective material is applied to the lateral protective member using at least one of: dip coating, spray coating, explosion coating, and electroplating.

4. The eyewear according to claim 1, wherein a marking is applied to the lateral protective member once the anti-reflective material is applied to the lateral protective member to make it visibly apparent to a user that the coating has been applied.

5. The eyewear according to claim 1, wherein the lateral protective member is inserted into the at least one recesses of the arm by a snap-in mechanism and/or magnetic mechanism.

6. The eyewear according to claim 2, wherein the lateral protective member is removably inserted into the at least one recesses of the arm.

7. A method of manufacturing eyewear comprising:
Forming a frame portion having a first and a second lens retainer, a pair of arms having at least one recess, and a nose bridge connecting the first and the second lens retainers thereto;
inserting a first and second lens into the first and the second lens retainers;
forming at least one lateral protective member having at least one attachment member;
coating the at least one lateral protective member with an anti-reflective material;
applying a marking to the at least one lateral protective member once the anti-reflective material coating has been applied to make it visibly apparent that a coating has been applied; and
attaching the at least one lateral protective member to the recesses of the at least one pair of arms.

8. Eyewear comprising:
a frame portion having a pair of arms and a brow bar having at least one recess;
a lens carrier comprising:
a first and a second lens retainers attached together by a nose bridge portion; and
a first and second lens for inserting into the first and second lens retainers;
wherein lens carrier is coated with an anti-reflective material; and
wherein it is visibly apparent to a user that the anti-reflective material has been applied to the lens carrier.

9. The eyewear according to claim 8, further comprising at least one lateral protective member that is removably attached to the frame portion.

10. The eyewear according to claim 9, wherein the at least one lateral protective member is attached to and extends from at least one recesses of the pair of arms.

11. The eyewear according to claim 8, wherein the anti-reflective material is applied to the lens carrier using at least one of: dip coating, spray coating, explosion coating, and electroplating.

12. The eyewear according to claim 9, wherein the at least one lateral protective member is coated with an anti-reflective material; and wherein it is visibly apparent to a user that the anti-reflective material has been applied to the lateral protective member.

13. The eyewear according to claim 11, wherein a marking is applied to the lateral protective member once the anti-reflective material is applied to the lateral protective member to make it visibly apparent to a user that the coating has been applied.

14. The eyewear according to claim 8, wherein a marking is applied to the lens carrier once the anti-reflective material is applied to the lens carrier to make it visibly apparent to a user that the coating has been applied.

15. The eyewear according to claim 12, wherein the lateral protective member can be inserted into the at least one recesses of the arm by a snap-in mechanism and/or magnetic mechanism.
